(19) United States
(12) Patent Application Publication
(10) Pub. No.: US 2022/0379446 A1
(43) Pub. Date: Dec. 1, 2022

(54) IMPACT TOOL

(71) Applicant: MILWAUKEE ELECTRIC TOOL CORPORATION, Brookfield, WI (US)

(72) Inventor: Benjamin J. Skelton, Milwaukee, WI (US)

(21) Appl. No.: 17/829,983

(22) Filed: Jun. 1, 2022

Related U.S. Application Data
(60) Provisional application No. 63/195,391, filed on Jun. 1, 2021.

(51) Int. Cl. B25B 21/02; B25F 5/00

(52) U.S. Cl. CPC B25B 21/02; B25F 5/001

(57) ABSTRACT

An impact tool includes a housing, an electric motor supported within the housing and having a motor shaft, a drive assembly including a camshaft rotatable about an axis, the camshaft having a stepped portion, and a gear assembly coupled between the motor shaft and the drive assembly. The gear assembly includes a ring gear having a projection with a support surface and a plurality of planet gears meshed with the ring gear. The impact tool further includes a plurality of pins coupling the planet gears to the camshaft. The support surface engages the stepped portion of the camshaft to rotationally support the camshaft.

### CROSS-REFERENCE TO RELATED APLICATIONS

This application claims priority to co-pending U.S. Provisional Application No. 63/195,391, filed Jun. 1, 2021, the entire content of which is incorporated herein by reference.

### FIELD OF THE INVENTION

The present invention relates to power tools, and more particularly to rotary impact tools.

### BACKGROUND OF THE INVENTION

Impact tools or wrenches are typically utilized to provide a striking rotational force, or intermittent applications of torque to a tool element or workpiece (e.g., a fastener) to either tighten or loosen the fastener.

### SUMMARY OF THE INVENTION

The present invention provides, in one aspect, an impact tool including a housing, an electric motor supported within the housing and having a motor shaft, a drive assembly including a camshaft rotatable about an axis, the camshaft having a stepped portion, and a gear assembly coupled between the motor shaft and the drive assembly. The gear assembly includes a ring gear having a projection with a support surface and a plurality of planet gears meshed with the ring gear. The impact tool further includes a plurality of pins coupling the planet gears to the camshaft. The support surface engages the stepped portion of the camshaft to rotationally support the camshaft.

The present invention provides, in another aspect, an impact tool including a housing, an electric motor supported within the housing and having a motor shaft, and a drive assembly including a camshaft rotatable about an axis. The camshaft includes a flange. The impact tool also includes a plurality of pins extending from the flange such that the pins are cantilevered from the flange. The impact tool also includes a gear assembly coupled between the motor shaft and the drive assembly. The gear assembly includes a ring gear and a plurality of planet gears rotatably supported by the pins and meshed with the ring gear.

The present invention provides, in yet another aspect, an impact tool including a housing, an electric motor supported within the housing and having a motor shaft, a drive assembly including a camshaft rotatable about an axis, the camshaft including a flange defining a rear surface of the camshaft, a plurality of pins extending from the flange such that the pins are cantilevered from the flange, and a gear assembly coupled between the motor shaft and the drive assembly. The gear assembly includes a ring gear including a projection having a front surface defining a front end of the ring gear and an axial support surface extending from the front surface, and a plurality of planet gears rotatably supported by the pins adjacent the rear surface and meshed with the ring gear. At least one of the front surface or the axial support surface of the projection engages the flange of the camshaft to support the camshaft.

Other features and aspects of the invention will become apparent by consideration of the following detailed description and accompanying drawings.

### BRIEF DESCRIPTION OF THE DRAWINGS

FIG. 1 is side partial cutaway view of a rotary impact tool according to an embodiment of the invention.

FIG. 2 is a side cross-sectional view a drive assembly of the rotary impact tool of FIG. 1.

FIG. 3 is a side cross-sectional view of a portion of the drive assembly of FIG. 2.

FIG. 4 is an exploded perspective view of a portion of the drive assembly of the rotary impact tool of FIG. 1.

FIG. 5 is another exploded perspective view of the portion of the drive assembly of FIG. 4.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

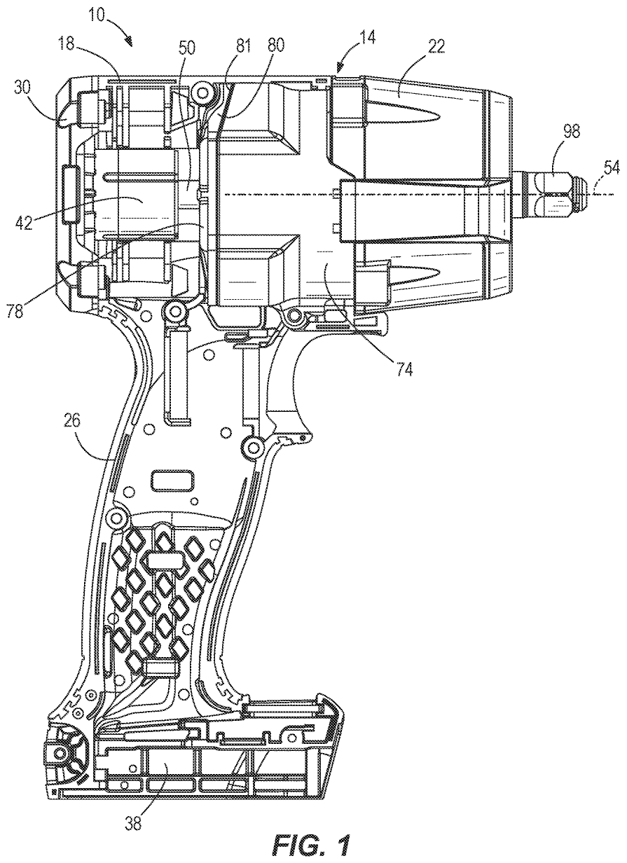

FIG. 1 illustrates a power tool in the form of an impact wrench 10. The impact wrench 10 includes a housing 14 with a motor housing portion 18, a front housing portion or gear case 22 coupled to the motor housing portion 18 (e.g., by a plurality of fasteners), and a handle portion 26 extending downward from the motor housing portion 18. In the illustrated embodiment, the handle portion 26 and the motor housing portion 18 are defined by cooperating clamshell halves. The illustrated housing 14 also includes an end cap 30 coupled to the motor housing portion 18 opposite the front housing portion 22.

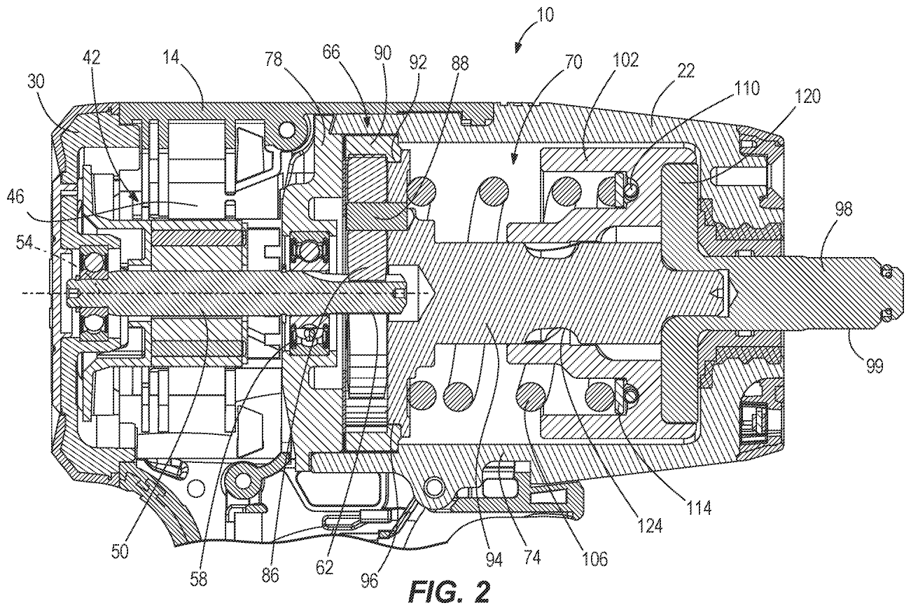

The impact wrench 10 has a battery (not shown) removably coupled to a battery receptacle 38 located at a bottom end of the handle portion 26. An electric motor 42, supported within the motor housing portion 18, receives power from the battery via the battery receptacle 38 when the battery is coupled to the battery receptacle 38. In the illustrated embodiment, the motor 42 is a brushless direct current (“BLDC”) motor with a stator 46 (FIG. 2) and an output shaft or rotor 50 that is rotatable about an axis 54 relative to the stator 46. In other embodiments, other types of motors may be used.

The impact wrench 10 also includes a switch (e.g., trigger switch; not shown) supported by the housing 14 that selectively electrically connects the motor 42 and the battery via a controller (which may include, amongst other components, a printed circuit board having one or more microprocessors and multiple field-effect transducers) to provide power to the motor 42. In other embodiments, the impact wrench 10 may include a power cord for electrically connecting the motor 42 to a source of AC power. As a further alternative, the impact wrench 10 may be configured to operate using a different power source (e.g., a pneumatic or hydraulic power source, etc.).

Referring to FIG. 2, the impact wrench 10 further includes a gear assembly 66 coupled to the motor output shaft 50 and a drive assembly or impact mechanism 70 coupled to an output of the gear assembly 66. The gear assembly 66 may be configured in any of a number of different ways to provide a speed reduction between the output shaft 50 and an input of the drive assembly 70. The gear assembly 66 is at least partially housed within a main body portion 74 of the gear case 22. The gear case 22 further includes a rear end cap 78 fixed to the main body portion 74 (e.g., by a plurality of fasteners, a press-fit, a threaded connection, or in any other suitable manner). The rear end cap 78 of the gear case 22 supports a bearing 58, which rotationally supports a front portion of the output shaft 50 of the motor 42. In some embodiments, the bearing 58 is insert molded within the rear end cap 78. In other embodiments, the radial bearing 58 may be press-fit within the rear end cap 78.

In the illustrated embodiment, the rear end cap 78 includes an angled flange portion 80 that is oriented at an oblique angle relative to the axis 54 (FIG. 1). The angled flange portion 80 cooperates with a correspondingly shaped angled recess 81 on the rear side of the main body portion 74 of the gear case 22, such that the overall interface between the rear end cap 78 and the main body portion 74 is non-planar. This non-planar interface aligns the rear end cap 78 at a proper rotational orientation with respect to the main body portion 74, thereby facilitating assembly of the gear case 22. In some embodiments, a washer or gasket (not shown) may be disposed between the rear end cap 78 and the main body portion 74 and angled to match the contour of the interface.

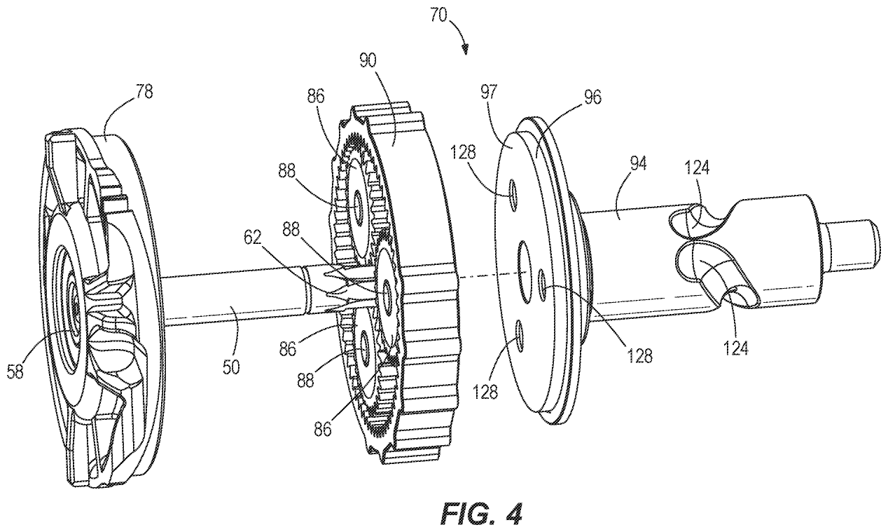

With reference to FIGS. 2 and 4, the gear assembly 66 includes a pinion 62 formed on the motor output shaft 50, a plurality of planet gears 86 meshed with the pinion 62, and a ring gear 90 meshed with the planet gears 86 and rotationally fixed within the gear case 22. The planet gears 86 orbit about the pinion 62 within the ring gear 90 and are each supported by a plurality of pins 88. The pins 88 are received in respective recesses 128 on a camshaft 94 of the drive assembly 70, such that the camshaft 94 acts as a planet carrier (FIG. 4). Accordingly, rotation of the motor output shaft 50 rotates the planet gears 86, which then advance along the inner circumference of the ring gear 90 and to rotate the camshaft 94.

In the illustrated embodiment of the impact wrench 10, the drive assembly 70 includes the camshaft 94, a hammer 102 supported on and axially slidable relative to the camshaft 94, and an anvil 98 (FIG. 2). The anvil 98 extends through a front end of the gear case 22 and includes a drive interface 99 (e.g., a square drive interface, a spline drive interface, or the like) to which a tool element (e.g., a socket, not shown) can be coupled for performing work on a workpiece (e.g., a fastener). The drive assembly 70 is configured to convert a continuous rotational force or torque, provided by motor 42 via the gear assembly 66, to a striking rotational force or intermittent applications of torque to the anvil 98 when the reaction torque on the anvil 98 (e.g., due to engagement between the tool element and a fastener being worked upon) exceeds a certain threshold.

With continued reference to FIG. 2, the drive assembly 70 further includes a spring 106 biasing the hammer 102 toward the front of the impact wrench 10 (i.e., in the right direction of FIG. 2). In other words, the spring 106 biases the hammer 102 in an axial direction toward the anvil 98, along the axis 54. A thrust bearing 110 and a thrust washer 114 are positioned between the spring 106 and the hammer 102. The thrust bearing 110 and the thrust washer 114 allow for the spring 106 and the camshaft 94 to continue to rotate relative to the hammer 102 after each impact strike when lugs (not shown) on the hammer 102 engage with corresponding anvil lugs 120 and rotation of the hammer 102 momentarily stops. The camshaft 94 further includes cam grooves 124 in which corresponding cam balls (not shown) are received. The cam balls are in driving engagement with the hammer 102, and movement of the cam balls within the cam grooves 124 allows for relative axial movement of the hammer 102 along the camshaft 94 when the hammer lugs and the anvil lugs 120 are engaged and the camshaft 94 continues to rotate.

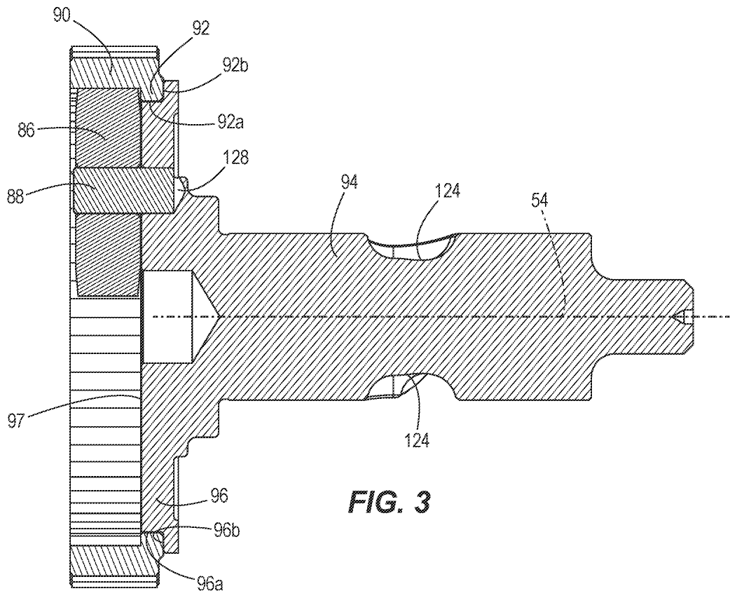

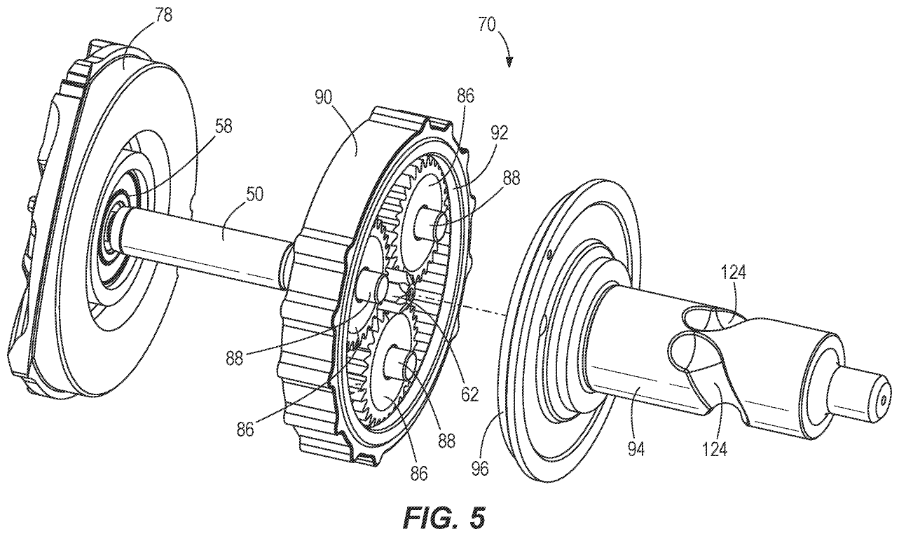

With reference to FIGS. 3-5, in the illustrated embodiment, the rear end portion of the camshaft 94 is rotatably supported by the ring gear 90. More specifically, the camshaft 94 includes a flange 96 defining a rear surface 97 of the camshaft 94. The flange 96 includes the recesses 128, which receive the pins 88 supporting the planet gears 96. The pins 88 may be press-fit into the recesses 128, or fixed within the recesses 128 in other ways. Best illustrated in FIG. 3, the flange 96 includes an axial surface 96a extending forward from the rear surface (i.e. in a direction parallel to the axis 54), and a radial surface 96b extending from the axial surface 96a, such that the flange 96 has a stepped configuration. In the illustrated embodiment, the radial surface 96b is perpendicular to the axial surface 96a.

With continued reference to FIG. 3, the ring gear 90 includes a projection 92 formed at a front side of the ring gear 90. The projection 92 includes an axial surface 92a, extending parallel to the axis 54, and a front surface 92b extending radially outwardly from the axial surface 92a. In the illustrated embodiment, the front surface 92b defines a front surface of the ring gear 90.

The rear surface 97 of the camshaft 94 is received within the ring gear 90, such that the axial surface 92a of the projection 92 engages the axial surface 96a of the flange 96, and the front surface 92b of the projection 92 engages the radial surface 96b of the flange 96. The projection 92 of the ring gear 90 thus supports the rear end of the camshaft 94 in both a rearward axial direction and a radial direction. The surfaces 96a, 96b are slidable along the surfaces 92a, 92b as the camshaft 94 rotates. In some embodiments, lubricant, such as grease or oil, may be provided between the surfaces 92a, 92b, 96a, 96b. Thus, the camshaft 94 is rotatably supported by the ring gear 90, without requiring any additional bushings or bearings. This reduces the length of the camshaft 94, which advantageously allows for a reduction in the overall length of the impact wrench 10.

With continued reference to FIG. 3, the planetary gears 86 are supported by each of the respective pins 88 extending from the recesses 128 in flange 96 of the camshaft 94. In the illustrated embodiment, each of these pins 88 is cantilevered from the flange 96. As such, the planet gears 86 are only supported on a single side of the camshaft 94. This simplifies the construction of the camshaft 94, compared to camshafts having a carrier portion with two, axially spaced flanges to support the planet gears therebetween. In addition, the overall length of the camshaft 94 is reduced, which advantageously allows for further reduction in the overall length of the impact wrench 10.

In operation of the impact wrench 10, an operator depresses the switch to activate the motor 42, which continuously drives the gear assembly 66 and the camshaft 94 via the output shaft 50. As the camshaft 94 rotates, the cam balls drive the hammer 102 to co-rotate with the camshaft 94, and the drive surfaces of hammer lugs engage, respectively, the driven surfaces of the anvil lugs 120 to provide an impact and to rotatably drive the anvil 98 and the tool element. After each impact, the hammer 102 moves or slides rearward along the camshaft 94, away from the anvil 98, so that the hammer lugs disengage the anvil lugs 120. As the hammer 102 moves rearward, the cam balls situated in the respective cam grooves 124 in the camshaft 94 move rearward in the cam grooves 124. The spring 106 stores some of the rearward energy of the hammer 102 to provide a return mechanism for the hammer 102. After the hammer lugs disengage the respective anvil lugs 120, the hammer 102 continues to rotate and moves or slides forwardly, toward the anvil 98, as the spring 106 releases its stored energy, until the drive surfaces of the hammer lugs re-engage the driven surfaces of the anvil lugs 120 to cause another impact.

Because the gears 86 are supported by the pins 88 in a cantilevered manner, the camshaft 94 does not need to extend rearwardly through the ring gear 90 to support the gears 86 from a second side. Furthermore, because the camshaft 94 is rotationally and radially supported by the ring gear 90, no additional bushing or bearing is required to support the rear end of the camshaft. Finally, the bearing 58 is supported by the rear end cap 78 of the gearcase 22, rather than being received within the camshaft 94. Thus, as discussed above, the overall axial length of the impact tool 10 can be reduced, which can allow for easier use of the tool 10 in tight spaces as compared to other impact tools having conventional camshafts.

Although the invention has been described in detail with reference to certain preferred embodiments, variations and modifications exist within the scope and spirit of one or more independent aspects of the invention as described.

Various features of the invention are set forth in the following claims.

What is claimed is:

1. An impact tool comprising:
a housing;
an electric motor supported within the housing and having a motor shaft;
a drive assembly including a camshaft rotatable about an axis, the camshaft having a stepped portion;
a gear assembly coupled between the motor shaft and the drive assembly, the gear assembly including
a ring gear having a projection with a support surface, and
a plurality of planet gears meshed with the ring gear; and
a plurality of pins coupling the planet gears to the camshaft,
wherein the support surface engages the stepped portion of the camshaft to rotationally support the camshaft.

2. The impact tool of claim 1, wherein the pins are cantilevered from the camshaft.

3. The impact tool of claim 1, wherein the drive assembly includes a hammer and an anvil, and wherein the hammer is configured to reciprocate along the camshaft to impact consecutive rotational impacts to the anvil.

4. The impact tool of claim 2, further comprising a battery pack configured to supply power to the electric motor.

5. The impact tool of claim 1, wherein the housing includes a gear case in which the drive assembly and the gear assembly are at least partially received, and a motor housing portion in which the electric motor is at least partially received.

6. The impact tool of claim 5, wherein the gear case includes a rear end cap, and wherein the motor shaft extends through the rear end cap.

7. The impact tool of claim 6, wherein the rear end cap includes a bearing insert molded into the rear end cap and rotationally supporting a portion of the motor shaft.

8. The impact tool of claim 1, wherein the projection includes a front surface defining a front end of the ring gear, and wherein the stepped portion of the camshaft includes an axial surface extending parallel to the axis and radial surface extending perpendicularly from the axial surface.

9. The impact tool of claim 8, wherein the axial surface slidably engages the support surface, and wherein the radial surface slidably engages the front surface such that the ring gear both axially and radially supports the camshaft.

10. An impact tool comprising:
a housing;
an electric motor supported within the housing and having a motor shaft;
a drive assembly including a camshaft rotatable about an axis, the camshaft including a flange;
a plurality of pins extending from the flange such that the pins are cantilevered from the flange; and
a gear assembly coupled between the motor shaft and the drive assembly, the gear assembly including
a ring gear, and
a plurality of planet gears rotatably supported by the pins and meshed with the ring gear.

11. The impact tool of claim 10, wherein the flange defines a rear end surface of the camshaft, and wherein the planet gears are positioned adjacent the rear end surface.

12. The impact tool of claim 11, wherein the flange includes a stepped configuration.

13. The impact tool of claim 11, wherein the rear end surface is received within the ring gear.

14. The impact tool of claim 11, wherein the flange includes an axial surface extending from the rear end surface and a radial surface extending from the axial surface.

15. The impact tool of claim 14, wherein at least one of the axial surface or the radial surface engages the ring gear such that the ring gear rotatably supports the camshaft.

16. The impact tool of claim 15, wherein both the axial surface and the radial surface engage the ring gear such that the ring gear axially and radially supports the camshaft.

17. The impact tool of claim 10, wherein the drive assembly includes a hammer and an anvil, and wherein the hammer is configured to reciprocate along the camshaft to impact consecutive rotational impacts to the anvil.

18. An impact tool comprising:
a housing;
an electric motor supported within the housing and having a motor shaft;
a drive assembly including a camshaft rotatable about an axis, the camshaft including a flange defining a rear surface of the camshaft;
a plurality of pins extending from the flange such that the pins are cantilevered from the flange; and
a gear assembly coupled between the motor shaft and the drive assembly, the gear assembly including
a ring gear including a projection having a front surface defining a front end of the ring gear and an axial surface extending from the front surface, and
a plurality of planet gears rotatably supported by the pins adjacent the rear surface and meshed with the ring gear,
wherein at least one of the front surface or the axial surface of the projection engages the flange of the camshaft to support the camshaft.

19. The impact tool of claim 18, wherein the drive assembly includes a hammer and an anvil, and wherein the hammer is configured to reciprocate along the camshaft to impact consecutive rotational impacts to the anvil.

20. The impact tool of claim 18, wherein both the axial surface and the front surface engage the flange such that the ring gear axially and radially supports the camshaft.
